(19) United States
(12) Patent Application Publication
(10) Pub. No.: US 2004/0155544 A1
(43) Pub. Date: Aug. 12, 2004

(54) Nonmetal bushing motor to fix a fan

(75) Inventor: Fu-Yin Wang, Taipei (TW)

Correspondence Address: TROXELL LAW OFFICE PLLC, SUITE 1404, 5205 LEESBURG PIKE, FALLS CHURCH, VA, 22041, US

(73) Assignee: Datech Technology Co., Ltd

(21) Appl. No.: 10/609,582

(22) Filed: Jul. 1, 2003

(30) Foreign Application Priority Data
Jan. 27, 2003 (TW) 092201458

(51) Int. Cl. H02K 5/00

(52) U.S. Cl. 310/91

(57) ABSTRACT

The present invention provides a Nonmetal bushing motor to fix a fan. The fan includes a frame body, a circuit board disposed on the frame body, a stator assembly mounted on the frame body, and a rotor assembly set on the outside of the stator assembly. A base is disposed in the center of the frame body and a bearing is disposed on the base. The bearing on the base is composed of a connection part and a hollow tube. The connection part and the hollow tube protrude out of the center of the base in one-piece design. At least one joint part is disposed on outer circumference of the connection part and at least one rib is disposed on outer circumference of the hollow tube. A lower bobbin is mounted on the button of the stator assembly. A hole is in the center of the lower bobbin and at least one obstructer corresponding to the joint part mounted on the bearing is disposed on inner circumference of the hole. By the lower bobbin, the stator assembly is firmly mounted on the bearing of the base, rather than get loose or fall off to interrupt the rotation operation of the fan while being forced or operated for a certain period.

### REFERENCE CITED

1. Taiwan Pat. No. 221590.

2. Taiwan Pat. No. 236471.

3. Taiwan Pat. No. 223374.

4. U.S. Pat. No. 6,102,675.

### FIELD OF THE INVENTION

The present invention is related to a nonmetal bushing motor to fix a fan. More particularly, by a lower bobbin, a stator assembly is firmly mounted on a bearing of a base, rather than get loose or fall off to interrupt the rotation operation of the fan while being forced or operated for a certain period.

### BACKGROUND OF THE INVENTION

The conventional stator assembly of a cooling fan, disclosed in the Taiwan Patent No. 221590, includes a chassis with a base thereof, containing a room; a circuit board disposed in the room of the chassis with several positioning holes set on some appropriate places of it; a coil base wound with coil, also disposed in the room of the chassis adjacent to the circuit board; a position device set on the coil base; which is characterized in that:

Several identical position holes are disposed on the base of the chassis corresponding to the position holes of the circuit board. Several position bars are disposed on one side of the position device adjacent to the circuit board for sequentially placing the position bars in the position holes of the base and the position holes of the circuit board.

The small stator assembly of a cooling fan, disclosed in the Taiwan Patent No. 236471, includes a stator coil, upper and lower magnetic poles, a circuit board, and a case, which is characterized in that:

A metal tube with a specific outside diameter passes through the stator coil, upper and lower magnetic poles, and the center of the circuit board. The button of the metal tube is pressed in the hole of the center of the case.

The small stator assembly of a cooling fan, disclosed in the Taiwan Patent No. 223374, includes a stator coil, upper and lower magnetic poles, a circuit board, and a case, which is characterized in that:

Circular lip with a larger outside diameter is disposed on the top of the metal tube with a single outside diameter. The diameter of the circular lip is larger than the inside diameter of the central hole of the upper and lower magnetic poles and the stator coil. The outside diameter of the metal tube is slightly larger than the inside diameter of the central hole of the upper and lower magnetic poles and the circuit board, and is a little bit smaller than the inside diameter of the central hole of the stator coil. The button of the metal tube presses through the upper magnetic pole, the stator coil, and the lower magnetic pole. The stator coil chipped tightly in the outside diameter of the lower part of the circular lip of the metal tube. Then, by the central hole of the circuit board, the circuit board is pressed to form a combined stator assembly outside the case, which will be moved into the case later. Since the outside diameter of the metal tube is slightly larger than the inside diameter of the central hole of the case, the metal tube is forced into the inside diameter of the central bar of the case, so that the whole stator assembly will be firmly mounted in the case.

Although all of the above methods can mount the stator assembly on the outside frame of the fan, in the stator assembly of a cooling fan disclosed in Taiwan Patent No. 221590, the position bar must cooperate with the position hole. Since the position bar is very small, it might be broken by extra force during fabrication or storage process.

In the small stator assembly of a cooling fan, disclosed in Taiwan Patent No. 236471 and No. 223374, the stator coil presses the metal tube so as to position the stator. Thus, after a certain time, the metal tube and the stator will get loose or fall off to interrupt the rotation operation of the fan due to the metal characteristic of elements. Therefore, it is apparent that the above conventional structure is insufficient for real practice.

### SUMMARY OF THE INVENTION

The main objective of the present invention is by a lower bobbin, to let a stator assembly be firmly mounted on a bearing of a base, rather than get loose or fall off to interrupt the rotation operation of the fan while being forced or operated for a certain period.

To achieve the above objective, a nonmetal bushing motor to fix a fan is provided, which includes a frame body, wherein a base is disposed in the center of the frame body and a bearing is disposed on the base; a circuit board disposed on the base of the frame body; a stator assembly, composed of a silicon steel assembly, an upper bobbin and a lower bobbin disposed on two sides of the silicon steel assembly, wherein by a bore disposed in the center of the silicon steel assembly, the stator assembly disposed on the outside of the bearing on the base electronically connects to the circuit board; a rotor assembly, composed of a blade, a magnetic lasso circularly disposed on the inside the blade, and an axis pivoted on the center of the blade, wherein by the axis, the rotor assembly is set on the outside of the bearing on the base and the magnetic lasso corresponds to the outside of the silicon steel assembly; which is characterized in that:

The bearing on the base is composed of a connection part and a hollow tube.

The connection part and the hollow tube protrude out of the center of the base in one-piece design. At least one joint part is disposed on outer circumference of the connection part and at least one rib is disposed on outer circumference of the hollow tube; and

A hole corresponding to the bore in the center of the silicon steel assembly is disposed in the center of the lower bobbin of the stator assembly, and at least one obstructer corresponding to the joint part mounted on the bearing is disposed on inner circumference of the hole. By the lower bobbin, the stator assembly is firmly mounted on the bearing of the base, rather than get loose or fall off to interrupt the rotation operation of the fan while being forced or operated for a certain period.

### BRIEF DESCRIPTION OF THE DRAWINGS

The present invention will be better understood from the following detailed description of preferred embodiments of the invention, taken in conjunction with the accompanying drawings, in which

FIG. 1 shows a separation view of the present invention;

FIG. 2 shows a cross-section view of the bearing of the present invention;

FIG. 3 shows a cross-section view of the lower bobbin of the present invention; and

FIG. 4 shows a cross-section view in combination configuration of the present invention

### DETAILED DESCRIPTION OF THE INVENTION

The following descriptions of the preferred embodiments are provided to understand the features and the structures of the present invention.

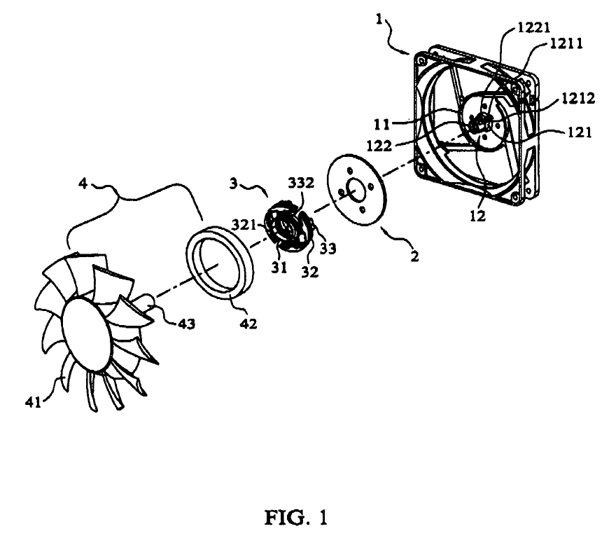

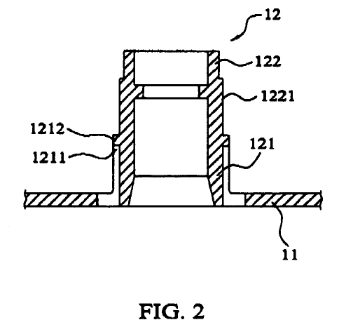

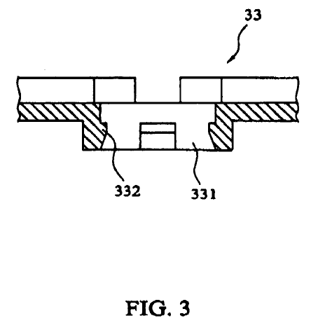

FIG. 1, FIG. 2, and FIG. 3 respectively show a separation view of the present invention, a cross-section view of the bearing of the present invention, and a cross-section view of the lower bobbin of the present invention. As shown in the drawings, the present invention provides a nonmetal bushing motor to fix a fan. The fan includes a frame body 1, a circuit board 2, a stator assembly 3, and a rotor assembly 4. By the present invention, a stator assembly 3 is firmly mounted on the frame body 1, rather than get loose or fall off to interrupt the rotation operation of the fan while being forced or operated for a certain period.

A base 11 is disposed in the center of the frame body 1 mentioned above and a bearing 12 is disposed on the base 11. The bearing 12 on the base 11 is composed of a connection part 121 and a hollow tube 122. The connection part 121 and the hollow tube 122 are made up with nonmetal materials and protrude out of the center of the base 11 in one-piece design. At least one joint part 1211 is disposed on outer circumference of the connection part 121. The joint part 1211 is a recess with a lock portion 1212 in one end. At least one rib 1221 is disposed on outer circumference of the hollow tube 122.

The circuit board 2 is disposed on the base 11 of the frame body 1 mentioned above.

The stator assembly 3 is composed of a silicon steel assembly 32, an upper bobbin 31 and a lower bobbin 33 disposed on two sides of the silicon steel assembly. By a bore 321 disposed in the center of the silicon steel assembly 32, the stator assembly 3 disposed on the outside of the bearing 12 on the base 11 electronically connects to the circuit board 2. Moreover, a lower bobbin 33 is mounted on the button of the stator assembly 3. A hole 331 corresponding to the bore 321 in the center of the silicon steel assembly 32 is disposed in the center of the lower bobbin 33, and at least one obstructer 332 corresponding to the joint part 1211 mounted on the bearing 12 is disposed on inner circumference of the hole 331. The obstructer 332 could be a hook.

The rotor assembly 4 is composed of a blade 41, a magnetic lasso 42 circularly disposed on the inside the blade 41, and an axis 43 pivoted on the center of the blade 41. By the axis 43, the rotor assembly 4 is set on the outside of the bearing 12 on the base 11 and the magnetic lasso 42 corresponds to the outside of the silicon steel assembly 32. In the novel structure of nonmetal bushing motor of the present invention, by the lower bobbin 33, the stator assembly 3 is firmly mounted on the bearing 12 of the base 11, rather than get loose or fall off to interrupt the rotation operation of the fan while being forced or operated for a certain period.

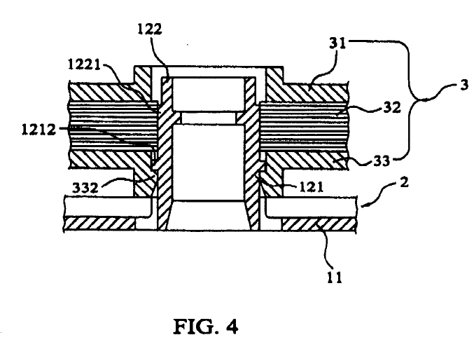

FIG. 4 shows a cross-section view in combination configuration of the present invention. As shown in the drawing, when the stator assembly 3 of the present invention is fabricated in the bearing 12 of the frame body 1, by the lower bobbin 33 disposed on the button of the stator assembly 3, users dispose the hole 331 corresponding to the central bore 321 of the lower bobbin 33 and the silicon steel assembly 32 on the bearing 12 in the center of the frame body 1. Then, the stator assembly 3 along with the lower bobbin 33 is forced to mount the lower bobbin 33 on the bearing 12. For the time being, in the lower bobbin 33, by the hole 331 passing through the outer portion of the rib 1221 disposed on the outer circumference of the hollow tube 122, the obstructer 332 on inner circumference of the hole 331 is mounted on the connection part 121 of the bearing 12 of the frame body 1. When being mounted, by the lock portion 1212 of the joint part 1211 in the recess, the obstructer 332 is leaded into the joint part 1211 in the recess. Since the obstructer 332 is a hook, when the obstructer 332 is disposed in the joint part 1211, by the cooperation of the lock portion 1212 and the obstructer 332, the bearing 12 can come into a lock configuration. The rib 1221 disposed on the outer circumference of the silicon steel assembly 32 of the stator assembly 3 and the hollow tube 122 also tightly cooperate with each other. Thus, the stator assembly 3 is mounted on the bearing 12 of the frame body 1. After being mounted, the obstructer 332 is limited in the joint part 1211. The obstructer 332 is a hook. Therefore, the stator assembly 3 cannot be pulled upward with the obstruction of the lock portion 1212. Furthermore, the stator assembly 3 cannot turn left or right under the cooperation of the rib 1221 disposed on the outer circumference of the silicon steel assembly 32 of the stator assembly 3 and the hollow tube 122 and the obstruction of two sides of the joint part 1211 in the recess. Therefore, by the lower bobbin 33, the present invention can firmly mount the stator assembly 3 on the bearing 12 of the base 11, rather than get loose or fall off to interrupt the rotation operation of the fan while being forced or operated for a certain period.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1. A nonmetal bushing motor to fix a fan, said fan comprising:
a frame body, a base is disposed in the center of said frame body and a bearing is disposed on said base;
a circuit board disposed on said base of said frame body;
a stator assembly, composed of a silicon steel assembly, an upper bobbin and a lower bobbin disposed on two sides of said silicon steel assembly, wherein by a bore disposed in the center of said silicon steel assembly, said stator assembly disposed on the outside of said bearing on said base electronically connects to said circuit board;
a rotor assembly, composed of a blade, a magnetic lasso circularly disposed on the inside the blade, and an axis pivoted on the center of said blade, wherein by said axis, said rotor assembly is set on the outside of said bearing on said base and said magnetic lasso corresponds to the outside of said silicon steel assembly; which is characterized in that:
said bearing on said base is composed of a connection part and a hollow tube, said connection part and said hollow tube protrude out of the center of said base in one-piece design, at least one joint part is disposed on outer circumference of said connection part, and at least one rib is disposed on outer circumference of said hollow tube; and
a hole corresponding to said bore in the center of said silicon steel assembly is disposed in the center of said lower bobbin of said stator assembly, and at least one obstructer corresponding to said joint part mounted on said bearing is disposed on inner circumference of said hole, whereby by said lower bobbin, said stator assembly is firmly mounted on said bearing of said base, rather than get loose or fall off to interrupt the rotation operation of said fan while being forced or operated for a certain period.

2. A nonmetal bushing motor to fix a fan of claim 1, wherein said connection part and said hollow tube are made up with nonmetal materials.

3. A nonmetal bushing motor to fix a fan of claim 1, wherein said joint part is a recess with a lock portion in one end.

4. A nonmetal bushing motor to fix a fan of claim 1, wherein said obstructer is a hook.
